(19) United States
(12) Patent Application Publication
(10) Pub. No.: US 2006/0156366 A1
(43) Pub. Date: Jul. 13, 2006

(54) Method and system for announcing a transport stream in a digital broadcast network

(76) Inventors: Jani Vare, Turku (FI); Matti Puputti, Turku (FI)

Correspondence Address: BANNER & WITCOFF, 1001 G STREET N W, SUITE 1100, WASHINGTON, DC, 20001, US

(21) Appl. No.: 10/509,375

(22) PCT Filed: Mar. 27, 2003
(86) PCT No.: PCT/FI03/00234

§ 371 Date: Jul. 13, 2005

(30) Foreign Application Priority Data
Mar. 28, 2002 (FI) 20020617

(51) Int. Cl. H04N 7/173

(52) U.S. Cl. 725/118; 725/117; 725/126

(57) ABSTRACT

A method and an arrangement for defining a sub-table structure for SI tables, which may be used to split one big Service information (SI) table into several smaller tables. The splitting into the smaller sub-tables (Sub-Ts) requires less transmitted bandwidth because all the SI do not need to be broadcast to End User Terminal (EUT). Also, the sub-table division enables relatively easy creation of local SI tables because sub-tables can serve as a basis for local Transport Stream (TS) announcement. By dividing tables into smaller ones, the amount of unnecessary information transmitted for the EUT is reduced. The TSs of an entire broadcast network can be divided. Moreover, neighbouring, or adjacent, TSs (cells) can announce and advertise their content to each other, and further to the EUT. A sub-table (Sub-T) of the TS is sent to the adjacent TS. The preferable embodiments enable the EUT for moving in DVB network in a blinded manner being not specially informed about where or under which cell's coverage the EUT is. However, the EUT is able to obtain the information what content (TSs) is locally available because of the sub-table structure.

### TECHNICAL FIELD OF THE INVENTION

This invention relates to systems and methods for distributing data over a communication link.

### BACKGROUND OF THE INVENTION

Broadcast has an almost century long tradition in radio. Even with TV, the history goes back to 1930's. Broadcasting has been successful throughout the world in bringing both entertainment and information to mass audiences.

The latest step in broadcasting is the digitalization of both radio and TV. Digital radio has not gained much acceptance on the market. However, many hope that digital TV will bring new benefits and services to the consumer and, as a result, generate new revenue streams for the broadcasting industry. The basic concept of the TV service itself has, however, not changed much. Rather, the TV lives on as before even if it has become digital.

In later half of 1990's we saw the boom of the Internet. A whole set of new services and content became available to the consumers during a short, revolutionary and hype intense period. That period introduced e-commerce, Internet Service Providers (ISPs), Portals, eyeballs game, dotcom companies, and even the new economy. The developments in both access technologies (e.g. ADSL) and coding technologies (e.g. MPEG-4 streaming) has made it possible to bring rich media content like video content to homes via the Internet. Despite of these technology and market breakthroughs media houses have been reluctant to distribute their content via the Internet due to its “free-of-charge” nature and the direct threat of piracy. Neither has Internet been able to challenge the role of traditional media as the primary advertisement platform despite its great popularity.

Broadcast provides the receiver device with huge amount of information. The receiver device needs to obtain linking and guidance information from broadcast information for obtaining services which can be indicated in the lining and guidance information. The linking and guidance information is typically contained in Service Information (SI) indicating and guiding the discovery of the services. The SI indicates various services of at least one broadcast network. The SI for various different services is broadcast at once for each receiver device, even if the receiver device wishes to or can receive only a certain service(s). The size of the SI becomes large due to the amount of the announced data. This may reserve broadcast resources and consume receiver resources as well.

In some previous approaches for obtaining the broadcast service, there has been further difficulties in efforts for trying to establish the SI announcing local services only, and therefore local services are applied but announcement has included various services typically for the broadcast network. In some other approaches, so called local services have been totally isolated from the actual broadcast transmission and either could not have knowledge about the other.

### SUMMARY OF THE INVENTION

Now a method and arrangement has been invented where data describing broadcast transmission guidance information enabling a receiver to obtain a service is partitioned for reducing the size of the broadcast transmission guidance information.

In accordance with a first aspect of the invention, there is provided a method for announcing transport streams that a digital broadcast network is adapted to transmit, the method comprising the steps of:
establishing at least one service information table for enabling a end user terminal to obtain the transport streams,
splitting the at least one service information table into sub-tables, wherein each sub-table identifies a certain transport stream, and
establishing a mother table for maintaining a sub-table of the certain transport stream and sub-tables of adjacent transport streams of the certain transport stream.

In accordance with a second aspect of the invention, there is provided a end user terminal for obtaining a transport stream that a digital broadcast network is adapted to transmit, the receiver comprising:
means for receiving a broadcast transmission, and
means for discovering a mother table from the broadcast transmission, the mother table announcing a set of sub-tables each sub-table identifying a local transport stream, wherein the transport streams indicated in the mother table comprise adjacent transport streams to each other.

In accordance with a third aspect of the invention, there is provided a system for delivering broadcast transport streams delivering services, the system comprising:
headends for splitting a service information table into sub-tables and for establishing a mother table, wherein each sub-table identifies a transport stream of a coincident headend, and wherein the mother table identifies the transport stream of the coincident headend and transport streams of adjacent headends to the coincident headend, and
at least one end user terminal for obtaining the broadcast transport streams.

In accordance with a fourth aspect of the invention, there is provided a transmitter for delivering broadcast transport streams delivering services, the transmitter comprising:
means for establishing at least one service information table for enabling a end user terminal to obtain the transport streams,
means for splitting the at least one service information table into sub-tables and for establishing a mother table, wherein each sub-table identifies a transport stream of a coincident headend, and wherein the mother table identifies the transport stream of the coincident headend and transport streams of adjacent headends to the coincident headend.

In accordance with a fourth aspect of the invention, there is provided a computer program product comprising a program of instructions executable by a computing system for processing an announcement of transport streams that a digital broadcast network is adapted to transmit, the computer program product comprising:
computer program code for causing the system to establish at least one service information table for enabling a end user terminal to obtain the transport streams,
computer program code for causing the system to split the at least one service information table into sub-tables, wherein each sub-table identifies a certain transport stream, and
computer program code for causing the system to establish a mother table for maintaining a sub-table of the certain transport stream and sub-tables of adjacent transport streams of the certain transport stream.

### BRIEF DESCRIPTION OF THE DRAWINGS

The invention will now be described, by way of example only, with reference to the accompanying drawings, in which:

FIG. 1 shows an example of splitting a SI table into sub-tables in accordance with an embodiment of the invention,

FIG. 2 shows an example of a DVB network system comprising headends for a delivery of the services to a End User Terminal in an embodiment of the invention,

FIG. 3 shows an example of mapping and an interdependence of sub-tables in transport streams in accordance with an embodiment of the invention,

FIG. 4 shows an example of an interdependence and a relation of mother table and sub-tables within the transport stream and between the transport streams in accordance with an embodiment of the invention,

FIG. 5 shows an example of an allocation of transport streams and their sub-tables in a DVB network and the relation, and the interdependence between the sub-tables and adjacent transport streams in accordance with an embodiment of the invention,

FIG. 6 depicts in a form of a flowchart a method for announcing adjacent transport streams locally in accordance with an embodiment of the invention,

FIG. 7 depicts in a form of a flowchart a method for obtaining a local transport stream in accordance with an embodiment of the invention,

FIG. 8 depicts an embodied broadcast receiver for receiving the transport stream in accordance with the sub-table structure,

FIG. 9 depicts an example of a end user terminal showing a program guide.

### DETAILED DESCRIPTION OF THE EMBODIMENTS

Preferable embodiments of the invention provide a method and an arrangement for defining a sub-table structure for SI tables, which may be used to split one big Service Information (SI) table into several smaller tables. Advantageously in broadcast transmission, the splitting into the smaller sub-tables (Sub-Ts) requires less transmitted bandwidth because all the SI do not need to be broadcast to a End User Terminal (EUT). Also, the sub-table division enables relatively easy creation of local SI tables because sub-tables can serve as a basis for local Transport Stream (TS) announcement. By dividing tables into smaller ones, the amount of unnecessary information transmitted for the EUT is reduced. The TSs of an entire broadcast network can be divided. Moreover, neighbouring, or adjacent, TSs (cells) can announce and advertise their content to each other, and further to the EUT. A sub-table (Sub-T) of the TS is sent to the adjacent TS. The preferable embodiments enable the EUT for moving in DVB network in a blinded manner being not specially informed about where or under which cell's coverage the EUT is. However, the EUT is able to obtain the information what content (TSs) is locally available because of the sub-table structure. In addition, the network does not need to know where the EUT is, and the content can still be delivered in a location based manner to the EUT because of the use of the sub-table structure. For example, in a Terrestrial Digital Video Broadcasting (DVB-T) network, there may exist several different TSs, which are not all available in the same location. Now a client, in a such location, doesn't need information on the every transport stream in the network. However, the client do need information of the transport streams available in that location. Advantageously, the not needed information about the transmission parameters is not announced for the EUT. Moreover, the local tables, resulting in local services, can be based on the sub-tables. The sub-tables are created once and do not need further modification. For example, a headend (HE) of the TS can send a sub-table to an adjacent headend (HE) broadcasting different TS, and the adjacent TS may apply the sub-table as such. Moreover, in DVB-T neighbouring cells can be announced by the sub-table structure.

In some preferred embodiments, each TS has a local mother table for each different SI table (i.e. one for BAT, one for SIT, etc.), preferably, only for those SI tables that has been split as proposed in this embodied invention. The mother table is built for each TS. Therefore, a headend of each cell builds a local mother table. The mother table announces what sub-tables (Sub-Ts) are included in the local TS. The preferred embodiments add a new level of splitting between table (table_id) and section (section_number). Now the original SI table is divided into sub-tables (Sub-Ts), and sub-tables (Sub-Ts) may still contain several sections. The invention is not limited to one table only, but may be applied in all SI tables, including any table added in future.

Digital Video Broadcasting (DVB) offers a high bandwidth transmission channel wherein delivery is broadcast, multicast or alternatively unicast. The high bandwidth transmission channel can offer a user of such system various services. Identifications for obtaining the various services are necessary to focus on appropriate services models and receivers. Preferably, a Terrestrial Digital Video Broadcasting (DVB-T) is applied in the invention.

The digital broadcast transmission provides a receiver device with huge amount of data information. A nature of the digital broadcast transmission is that the transmission is streaming distribution typically to multiple receivers applying broadcast or multicast, or alternatively unicast point-to-point distribution to a single receiver. The receiver device should be able to find the relevant data information among the huge amount of transmitted data information. The receiver device requires certain parameters in order to be able to receive the relevant service which can be intended for or desired by the receiver device. Because the digital broadcast transmission can distribute a lot of data, it can also distribute the parameters which enable the receiver device to discover the service among transmitted information. These parameters are digitally broadcast to the receiver device. The receiver device recognizes them and can modify itself in accordance with the parameters. Therefore, the receiver device can now start receiving the service, by identifing the relevant data from the huge amount of data in the broadcast transmission. Because of physical limitation of the bandwidth and possibly location dependent nature, and that the receiver device may typically be able to receive certain services, it is beneficial to focus on the reception parameters of the certain services only, and not to all reception parameters indicating other services that are not available for or interested by the receiver device.

Some embodiments of the applied transfer protocol in the invention are based on the methods and systems presented in a specification ISO/IEC 13818-1 Information Technology—Generic Coding of Moving Picture and Associated Audio Information: Systems on pages viii-xii, incorporated herein as a reference. The ISO/IIEC 13818-1 defines a Transport Stream (TS) which forms a basis for the service delivery and for the DVB.

Some embodiments of the invention apply Service Information (SI). The SI comprises digital data describing the delivery system, content and scheduling/timing of broadcast data streams etc. The SI includes MPEG-2 PSI (Program Specific Information) together with independently defined extensions. The PSI data provides information to enable automatic configuration of the receiver to demultiplex and decode the various streams of programs within the multiplex. Some more technical details of SI can be found from a publication ETSI EN 300 468 v.1.4.1. (2000-11) Digital Video Broadcasting (DVB); Specification for Service Information (SI) in DVB systems, incorporated herein as a reference. Certain SI tables comprise typically at least one (or several) “for loop”. Advantageously, the for loop can be split into several sub-tables (Sub-Ts) or alternatively referred to as sections. Each one containing information on one cycle of the for loop. As the for loop can indicate a certain TS, the sub-table (Sub-T) may perform it also.

It is noted the SI and/or possibly the SI table(s) in this connection comprise the PSI and PSI table(S) also.

Some embodiments of the invention will be described in connection with Bouqet Association Table (BAT). Regarding the invention, the operation and structure of the BAT are described to a degree that may assist in comprehending the sub-table structure for the SI tables. Other applicable tables of the SI can be applied as well. The BAT provides information relating to bouquets. As well as giving the name of the bouquet, it provides a list of services for each bouquet. The bouquet comprises a collection of services marketed as a single entity, and it may traverse the boundary of a network. Some more technical details of the BAT can be found from the EN 300 468 on pages 17-19, incorporated herein as a reference. The BAT comprises the at least one for loop. The for loop comprises a transport_stream_id. Advantageously, the for loop of the BAT uniquely identifies the TS. Therefore, because each loop can be divided into the sub-table (Sub-T), each sub-table (Sub-T) can uniquely identify the TS. The for loop comprises also original_network_id and descriptor calls. The for loop comprises also bits which are reserved for some future use.

Exemplary transport_stream_id is a unique identifier of the TS within the originating network. The transport_stream_id comprises a 16-bit field which serves as a label for identification of the TS from any other multiplex within the delivery system.

Some embodiments of the invention apply a broadcast cell. The cell is a geographical area that is covered with DVB-T signal by means of one or more transmitters each radiating at least one particular transport stream on a certain frequency. Typically, a particular transport stream on only one frequency is applied in the cell. The cell may in addition contain repeaters. Two neighbouring cells may have an intersection. The cell_id that is used to uniquely identify a cell can be unique within each original_network_id. The cell may have sub-cells having different operation frequencies. Preferably, the cell contains a TS.

Some embodiments of the invention apply a headend (HE). The headend (HE) equipment provides means for broadcasting the transport stream within the cell. Moreover, the headend may deliver the TS in other broadcasting environment such as cable and satellite. Typically, an operator of the broadcast network operates the headend.

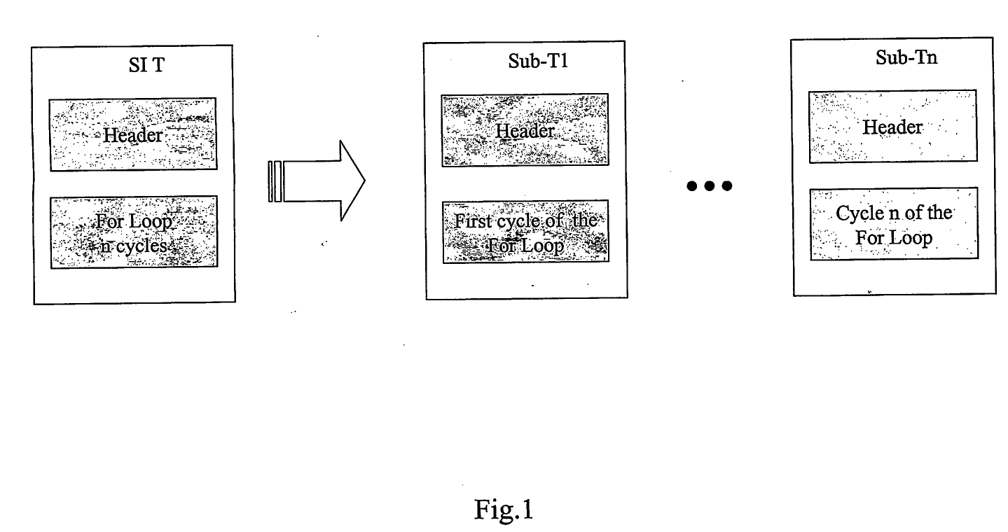

FIG. 1 has been described in the foregoing. In the following, corresponding reference signs have been applied to corresponding parts. FIG. 1 shows an example of a division of a SI table into several sub-tables (Sub-Ts) in accordance with an embodiment of the invention. The SI table (SI T) comprises a header for identification of the table and the at least one for loop. Typically, there are several for loops. The exemplary for loop is described above referring to the SI or the BAT. Advantageously, the for loop can be split into several sub-tables (Sub-T1-Sub-Tn) or alternatively referred to as sections. Each one containing information on the coincident one cycle of the for loop. Each sub-table (Sub-T1-Sub-Tn) contains the header and respective cycle. Thus, the first cycle of the for loop is contained in the first sub-table (Sub-T1). The cycle n of the for loop is contained in the nth sub-table (Sub-Tn).

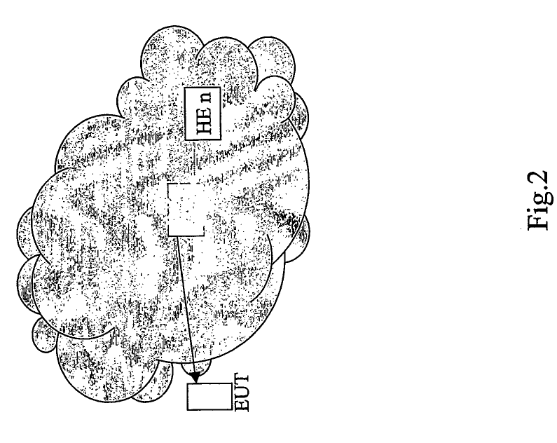

FIG. 2 has been described in the foregoing. In the following, corresponding reference signs have been applied to corresponding parts. FIG. 2 shows an example of a DVB network comprising headends for a delivery of the services to a End User Terminal in an embodiment of the invention. In the embodiment of FIG. 2 for illustrative purposes only n headends (HE-He n) are depicted. The exemplary headend is described above. The headend (HE) provides the operator means for the broadcasting of the TS. Thus, in FIG. 2 n TSs can be applied. The broadcasting of FIG. 2 can apply two principles: 1) Headend (HE) of each TS builds a local BAT, announcing information of the local TS. Thus, each TS delivers at least the local BAT (of the local TS) to the EUT. 2) In case a headend (HE) of the TS wants to announce information of another TS (operated by another HE), it only needs to receive the local table of that other TS, and to transmit it as it is (remultiplexed without modifications). In such a case, a TS would contain more than one BAT tables, each identified by transport_stream_id.

Still referring to the example of FIG. 2, the network operator needs to build each table only once (locally), but may use these tables in several TSs. Only delivering table to the headend (HE) of the other TS is required. This provides advantages as the other headend (HE) doesn't need to modify the table. This can lessen redundancy, and further there is no need to build same information in multiple location—table is build in one location only and delivered without modifications to multiple location. Thus, various TSs can apply the same table, and there is no need to establish or modify the table for different TSs.

Some embodiments of the invention apply the DVB-T. The DVB-T constitutes a cellular broadcasting network. Typically, the DVB-T correspondingly give birth a mobile EUT. In case of cellular DVB-T network, the mobile EUT may require information about neighbouring cells. However, the EUT doesn't need to know about cells beyond neighbouring cells. For the network operator, this embodied invention may help or reduce burden in building such local tables. The headend (HE) of each cell could build all local tables (BAT, etc.), and the headend (HE) could deliver them to all (or some) headends (HE) of other cells of the network. The headend (HE) of each cell may individually decide which of the other (non-local) tables to deliver.

Still referring to the examples of the cell embodiment. When applying the for-loops, implementation can be the following. Each cell builds new set of tables, announcing adjacent cells only. Problem is that each cell needs to know the information of each adjacent cell to be able to build a table announcing adjacent cell. Therefore, tables with identical information are build in several location which may or may not cause redundancy.

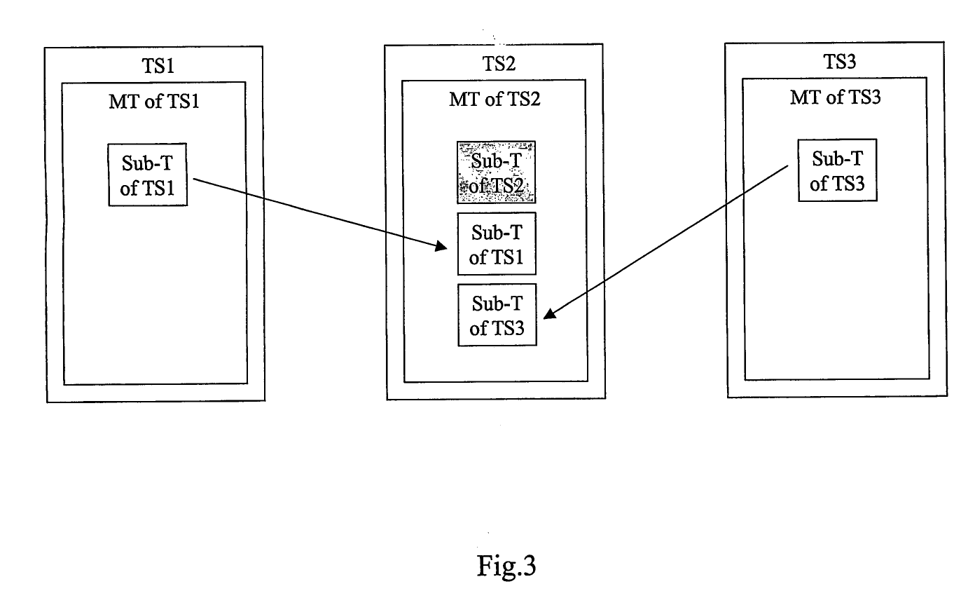

Some embodiments of the invention apply the mother table (MT). FIG. 3 shows an example of an interdependence and a relation of a mother table and sub-tables within the transport stream in accordance with an embodiment of the invention. Each Transport Stream (TS1,TS2,TS3) comprises the mother table (MT1,MT2,MT3). The MT is created for maintaining the sub-tables (Sub-Ts) or information indicating the sub-tables (Sub-Ts). The MT maps or links a sub-table (Sub-T) coincident with the applied TS. Thus, TS1 contains MT1, the MT1 indicating sub-table 1. TS2 has two adjacent or neighbouring TSs, TS1 and TS3. In addition to the own sub-tables, the mother table (MT) of TS2 comprises sub-tables of the adjacent TSs (sub-table 1 & sub-table 3). The tables are included in the TS for being broadcast to the EUT. Therefore, while receiving the TS2 the EUT obtains information on TS1 & TS2 in the form on sub-tables (sub-table 1 & sub-table 3).

Still referring to the example of the mother table. The inclusion of the mother table reduces the problem of redundancy in the cellular broadcast network example. Advantageously, the mother table (MT) can be used to identify how many sub-tables (Sub-Ts) there is transmitted within a TS. Also, the mother table (MT) can be applied to identify whether any sub-table (Sub-T) has been updated and/or what sub-table (Sub-T) has been updated. This helps the EUT, in some cases, to know and identify the sub-tables (Sub-Ts), or the EUT does not even have to know this at all. The broadcast network can perform this duty without the EUT being specially informed of the sub-tables (Sub-Ts). The EUT obtains the result only which in this case would be information on the available and/or neighbouring TS(s). Alternatively, the EUT may be provided with a filter to receive all possible sub-tables (Sub-Ts), and to check each one of them to know whether one is added/removed/updated. However, preferably, the broadcast network does this by the appliance of the mother table (MT). Each TS delivers the mother table (MT) for each set of sub-tables, for example, BAT mother table announcing all sub-BAT tables delivered within the TS. The mother table (MT) of a TS announces: What sub-tables (Sub-Ts) are included within the TS, and version number of each sub-table (Sub-T). The EUT only needs to receive the mother-table (MT) to know how many sub-tables (Sub-Ts) there is, and whether any of them has changed.

Still referring to the example of the mother table (MT). Thus, each TS has a local mother table (MT) for each different SI table, for example, one for BAT, one for SIT, etc. Naturally, only for those SI tables that has been divided as proposed in some embodiments of the invention. The mother table (MT) is built for each TS. Preferably, the headend (HE) of each cell builds the local mother table (MT). The mother table (MT) announces what sub-tables (Sub-Ts) are included in the local TS. This would require some changes in the existing standards ISO 13818-1 & EN 300 468. Preferably, the embodied invention is applicable to new or future tables and their structures/interdependencies. Also, the tables and their structures that can be modified with a reasonable burden are preferably applied. Therefore, the standard and the technical art gradually adapts to the principle if the change is not too radical thorough modification.

One possible standard modification could be that each TS of the network announces all other TSs of the network. However, preferably, only the adjacent or neighbouring TSs of the cell is announced.

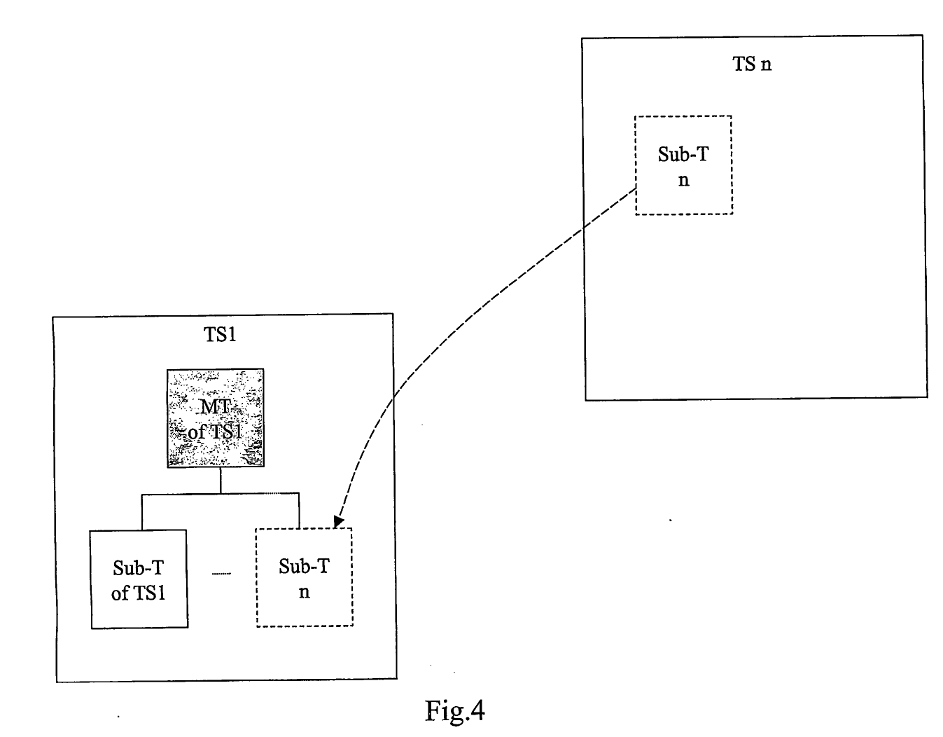

FIG. 4 has been described in the foregoing. In the following, corresponding reference signs have been applied to corresponding parts. FIG. 4 shows an example of an interdependence and a relation of mother table (MT) and sub-tables (Sub-Ts) within the transport stream and between the transport streams in accordance with an embodiment of the invention. The example of FIG. 4 contains Transport Streams (TSs) 1 to n. The structure of the division of the tables is contained within the each TS for each corresponding set of tables. The mother table (MT) of TS1 represents an upper level hierarchy in comparison with the sub-tables (Sub-T1-Sub-Tn). Basically, each TS contains the respective sub-table, for example, TS1 contains Sub-T1. In addition, there is being exchanged some information relating to sub-tables or announced some sub-tables. The sub-tables are announced between the TSs and possibly corresponding cells. The network operator of the broadcast network can decide which sub-tables are included in which cell, and which information on sub-tables are exchanged. Alternatively, as the TSs are identified in accordance with, for example, transport_stream_id, and the identities are transferred to other cell possibly in a periodical manner. Now, the identifiers are collected in the neighbouring cells, and the sub-table information is being exchanged.

Still referring to the example of FIG. 4, the MT of the TS1 maps/indicates/links the sub-table n. Thus, the sub-table n has been obtained and identifies the TSn. Thus, the identification of the adjacent TSs are contained within the transmission of TS1.

The embodied invention provide a flexible and a tempted way to advertise various service. The services, typically represented by the TSs, can be advertised to other services. Thus, there may be advertisement between different operators or between different broadcast cells.

Some embodiments of the invention provides support for the mobile clients. Typically, the mobile client needs to know about neighbouring cells (or adjacent transport streams). Therefore, each cell (transport stream) shall contain SI tables announcing information about the neighbouring cell and services available therein.

However, in a case the network doesn't know about the location of the client, network may not know what cells should be announced to the particular client. Network may solve this problem by using the following method. Each cell announces a subset of cells of the network. The subset includes all adjacent (or alternatively expressed neighbouring) cells. The second method means, that each cell may need to create its own SI tables. For example, cell A announces also cell B, but not cell D. Cell B announces also cells A and D. Now cell A and B needs to build partially similar, but partially different tables. For the second method, the embodied invention supports a method to make it easier for the network operator to build and manage tables. Each cell creates tables announcing the cell itself. The table is delivered to other cells, which do not need to modify the table at all. Instead, cells create the mother table (MT), listing what sub-tables (Sub-Ts) are transmitted. It is up to the network operator to decide which sub-tables (Sub-Ts) are included in which cell. Alternatively, as the TSs are identified in accordance with, for example, the transport_stream_id, and the identifiers are transferred to other cell possibly in a periodical manner, the identifiers are collected in the neighbouring cells, and the sub-table information is being exchanged.

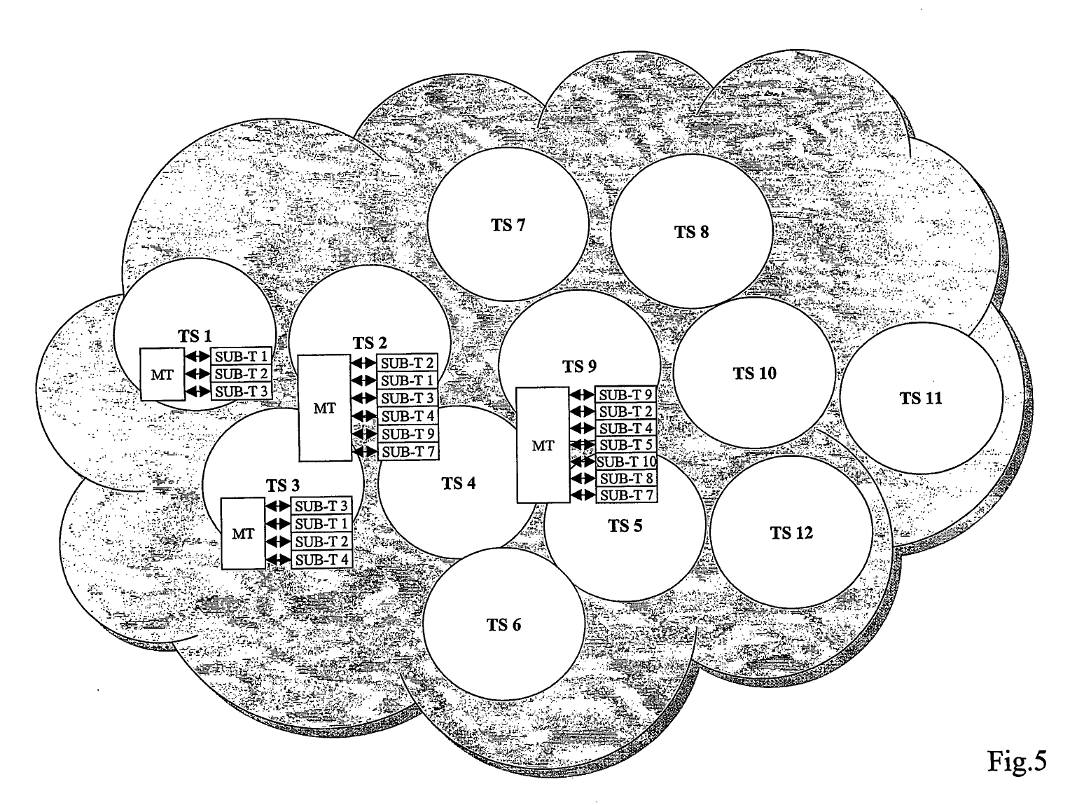

FIG. 5 has been described in the foregoing. In the following, corresponding reference signs have been applied to corresponding parts. FIG. 5 shows an example of an allocation of transport streams and their sub-tables in a DVB network and the relation, and the interdependence between the sub-tables and adjacent transport streams in accordance with an embodiment of the invention. FIG. 5 illustrates the allocation of the TSs and sub-tables (Sub-Ts) in the single DVB network. FIG. 5 illustrates how each TS has its own sub-table (Sub-T) and the sub-tables (Sub-Ts) from the surrounding TSs indicated by the mother table (MT). For example, TS 1 has own sub-table (Sub-T1) and the sub-tables of the TS2 and TS3 (Sub-T2 and Sub-T3). In the example of FIG. 5, TS1 contains two adjacent or neighbouring TSs, namely, TS2 and TS3. The mother table (MT) of TS1 maps or links the sub-table 1 (Sub-T1) and also sub-tables 2 and 3 (Sub-T2 and 3). Advantageously, the broadcast reception parameters within the TS1 comprises parameters relating to sub-tables 1, 2 and 3 (Sub-T1, Sub-T2 & Sub-T3). Therefore, a great deal of bandwidth is saved since the substantial reception parameters for other TSs (4-12) are not required or contained within the TS1.

Some embodiments of the invention apply re-transmission. The re-transmission in here refers to a situation, where a table is re-transmitted within a cell every Xth seconds. Two ways for re-transmission can be introduced: 1) Cell that transmits the sub-table (Sub-T) (received from another cell) will store the content of the table and handle the re-transmitting individually (no synchronization between the cell creating the sub-table (Sub-T) and the cell transmitting it). 2) Cell creating the sub-table (Sub-T) handles the re-transmitting. Sub-table (Sub-T) is re-transmitted to other cells every Xth seconds, and the transmitting cell only adds the table into the transport stream (TS) when it is received from the first cell.

Some embodiments of the invention apply announcement of the MT. The announcement of the MT can be similar to the announcement of the existing DVB tables which is implemented by, for example, PID (Packet Identifier) and table_id. The table_id defines the type of the table. If the client knows what table is wanted, it knows the table_id according to the standardized value. In addition, the client wants to obtain the PID, by which a table is transported. The PID of the MT can be the following. 1) Fixed PID is applies. For example, BAT applies the PID having a value 0x0011. If the BAT is divided into the MT and into the Sub-T(s), the MT may apply the value 0x0011 of the PID. 2) The PID the MT is described in other table. The other table's PID is fixed or described in a further table. This may result in a chain where one end of the chain has the fixed PID, and there is no need for the client to start looking for the PID. The MT may describe the PID(s) of the Sub-T(s). Moreover, the MT and the Sub-T(s) can be defined having the same PID. Typically, the MT and the Sub-T contains a different table_id. If the same PID is applied, they have different table_ids.

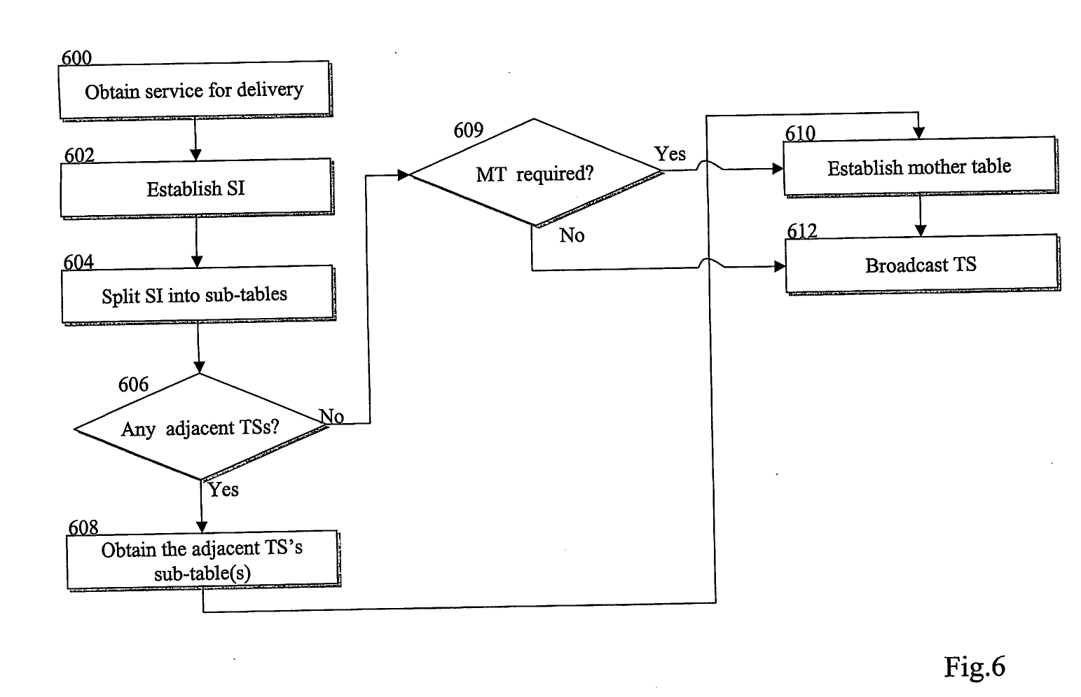

FIG. 6 has been described in the foregoing. In the following, corresponding reference signs have been applied to corresponding parts. FIG. 6 depicts in a form of a flowchart a method for announcing adjacent transport streams locally in accordance with an embodiment of the invention. A tendency of the example of FIG. 6 is to relief the broadcast parameters, and yet maintaining the delivery of certain service and relatively obtainable services, typically located in adjacent cells. In step 600 the service provider provides the operator of the digital broadcast network a service(s) to be distributed. In step 602 there is established the SI. The SI comprises tables for enabling the EUT to obtain the TS and eventually the service. In step 604 the SI is split into the sub-tables (Sub-Ts). Some SI tables or just one table can be split into sub-tables (Sub-Ts). In condition 606, there is being checked whether there exists any adjacent or neighbouring TSs. The cell containing the headend obtains information on neighbouring cells about applied TSs. Also, the cell can inform the neighbouring cells about the TS of the cell. If there are any adjacent TSs, there is obtained information on the sub-tables (Sub-Ts) of the adjacent TSs in step 608. In step 610 the mother table is established. The Sub-tables (Sub-Ts) of the adjacent TSs are mapped into the mother table (MT) in step 610. Moreover, the mother table maps the sub-table (Sub-T) of applied TS. In step 612 the TS is broadcast. Preferably, a terrestrial broadcast transmission containing cells is transmitted but other systems can be applied as well. Thus, the transmitted broadcast transmission has also certain characterizing parameters, for example, the tables. The receiver is able to obtain the SI because the receiver contains existing parameters for catching the SI from the broadcast transmission. Therefore, the EUT is able to obtain a local TS announced by reduced SI. In the condition 606, if there are not any adjacent TSs available, there is being checked whether the mother table (MT) is required in condition 609. If the MT is required, the MT is established as referred to in the step 610. If the MT is not required, the TS is broadcast to the EUT as referred in to the step 612. There may or may not be a need for establishing the mother table (MT).

Preferably, the operations of the embodied FIG. 6 are performed in the headend (HE) equipment.

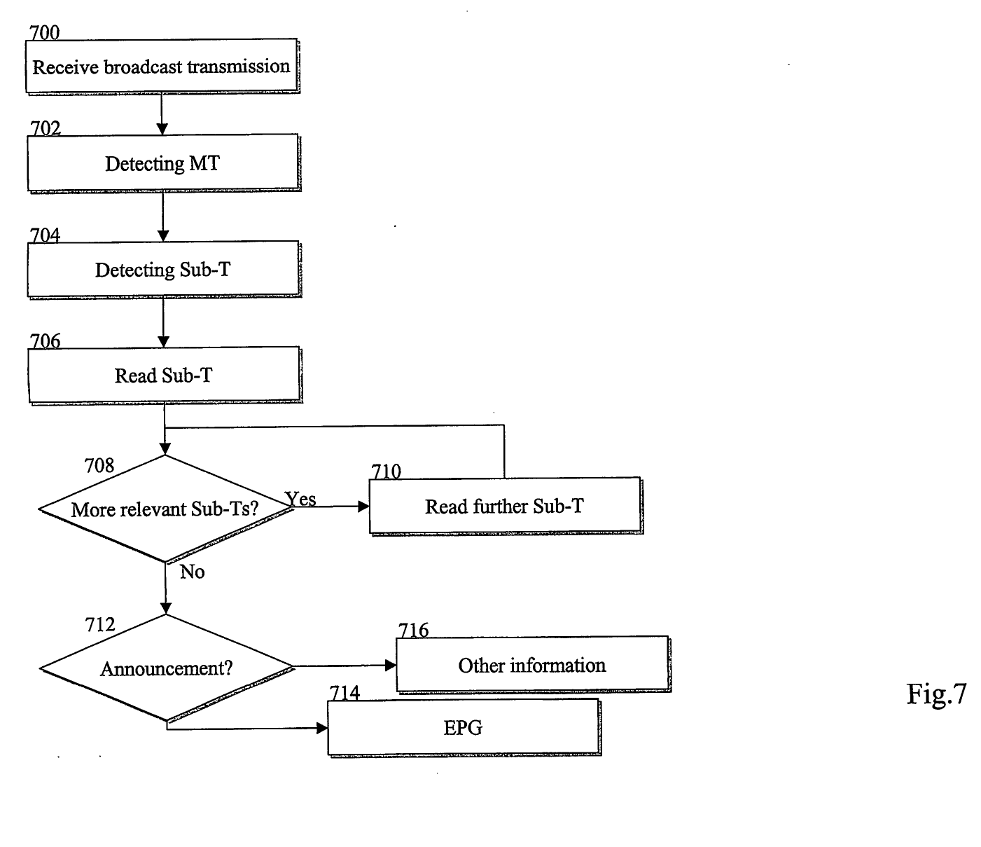

FIG. 7 has been described in the foregoing. In the following, corresponding reference signs have been applied to corresponding parts. FIG. 7 depicts in a form of a flowchart a method for obtaining a local transport stream in accordance with an embodiment of the invention. In step 700 there is received the broadcast transmission generally. Preferable, the broadcast transmission is received at the mobile [symbol] but it should be noted that other broadcast reception principles than the DVB-T was applied as well. The EUT receives the broadcast transmission. The broadcast transmission contains the SI tables such as the BAT. For example, the BAT table is obtained from the received broadcast transmission. In step 702, the MT is detected. The EUT detects the MT from the received broadcast transmission, and reads the MT. For example, the MT of the BAT is detected and read. In step 704 the sub-table (Sub-T) information is detected. As the EUT obtains the MT, the MT indicates the sub-table(s) (Sub-T(s)) to the EUT. In step 706 a sub-table (Sub-T) is read. Preferably, the first sub-table (Sub-T) indicated in the mother table MT is read first. For example, the Sub-T of the BAT is detected and read. In condition 708, there is being checked whether more relevant sub-tables (Sub-Ts) exists. The EUT may check whether it can obtain the TS indicated in the more sub-tables (Sub-Ts). For example, if the EUT is not the mobile one and may not move, it can decide to not read any further sub-tables (Sub-Ts). Alternatively, the user of the EUT can make the decision whether he is interested in further services indicated in the further sub-tables (Sub-Ts). In step 710 the further sub-table (Sub-T) is read. Advantageously, the further sub-table (Sub-T) indicates the neighbouring TS. If more sub-tables (Sub-Ts) are not read or there are not any more them, the information that the sub-table(s) (Sub-T(s)) has is announced in condition 712. There is also checked whether the information contain an Electronic Program Guide (EPG). The EPG shows a program list of services. Advantageously, the EPG can be location/cell dependent showing only the available program in the cell. Moreover, any adjacent programs in the adjacent TSs can be shown. If the EPG is not disclosed in the information other info that the read sub-table (Sub-T) has is ready to be applied in step 716. For example, the EUT may obtain tuning parameters. Alternatively, the EPG and the facility may be simultaneously obtained.

Still referring to the example of the mobility. Advantageously, the sub-table (Sub-T) identifies a certain TS which typically is a local TS of a certain cell. The adjacent TSs are indicated in the MT by the Sub-T(s). If there is detected the adjacent TSs, the information about the adjacent TSs enable advertisements. The adjacent TSs can be advertised to the EUT. In addition, the links to the adjacent TSs enable the EUT to move in the broadcast network, and yet being coupled with the network. Thus, the information on the adjacent TSs (cells) enables a handover in the network while moving from a cell to an adjacent cell. The TS may or may not be a local one. Also, roaming between the cells is applicable.

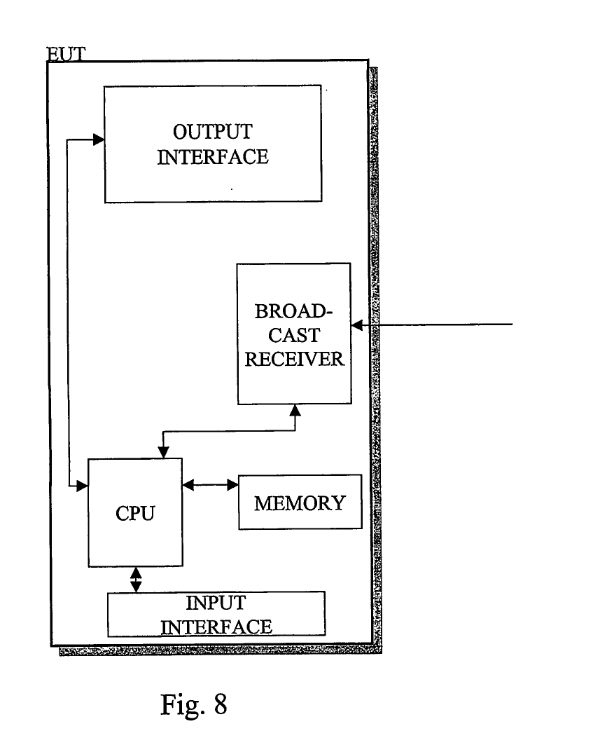

Preferably, the EUT of FIG. 8 performs the function of the example of FIG. 7.

FIG. 8 has been described in the foregoing. In the following, corresponding reference signs have been applied to corresponding parts. FIG. 8 depicts an exemplary block diagram of a End User Terminal for receiving a Transmission Stream in accordance with the sub-table structure. The End User Terminal (EUT) of FIG. 8 may be used in the example(s) of FIGS. 1-6. The EUT comprises a processing unit (CPU), a broadcast receiver part and a user interface UI (Output interface, Input interface). The broadcast receiver part and the user interface (UI) are coupled with the processing unit (CPU). The user interface (UI) comprises a display and a keyboard to enable a user to use the EUT. In addition, the user interface UI comprises a microphone and a speaker for receiving and producing audio signals. The user interface UI may also comprise voice recognition (not shown). The processing unit (CPU) comprises a microprocessor (not shown), a memory and software SW (not shown). The software SW is stored in the memory. The microprocessor controls, on the basis of the software SW, the operation of the EUT, such as receiving of the multiplex, the identification of the service(s), the reception of the mother table (MT), the reception of the sub-tables (Sub-Ts), displaying output in the user interface UI and the reading of inputs received from the user interface UI. Some operations are described in the examples of FIGS. 1-6. For example, the software SW comprises means for identifying the signal, means for demodulation, means for identifyig the service, means for identifying characteristics of the adjacent TSs, and means for receiving IP based services. Alternatively, hardware or middleware implementation can be applied (not shown). The EUT can be a hand-held device which the user can comfortably carry. Advantageously, the EUT can comprise a cellular mobile phone which contains the broadcast receiver for receiving the broadcast transmission (the TS) and means for interaction via the cellular mobile phone unit. Therefore, the EUT can also interact with the service providers. An exemplary EUT can be mediamaster™ or mediaterminal™ of Nokia™ where the invention can be embodied. Both are digital TV receivers enabling the reception of the DVB.

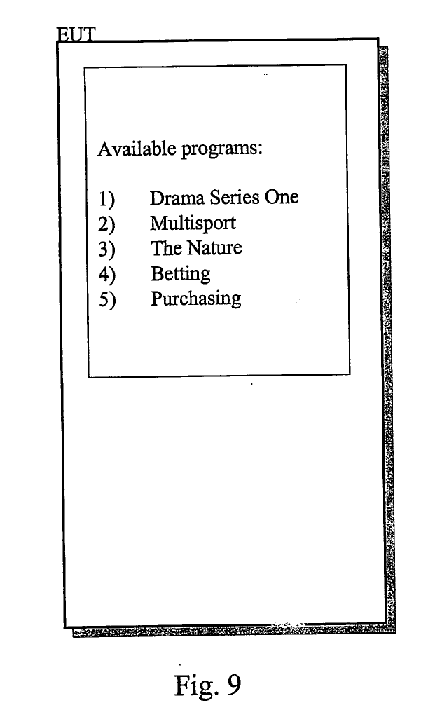

FIG. 8 has been described in the foregoing. In the following, corresponding reference signs have been applied to corresponding parts. FIG. 9 depicts an example of a end user terminal showing a program guide. In the example of FIG. 9, the example of FIG. 7 can be applied and the EPG obtained. The exemplary EPG shows the user of the EUT program listing for available service. The EPG is cell based show services of the TS of the applied cell. Also, the neighbouring services contained in the adjacent TSs can be shown to the user via the EPG or an additional EPG.

The invention has been described in connection with the sub-table structure. It should be noted that similar structural division can be obtained by applying a sectioning of the for loop of the table. One table is divided into several sections, where each one could be used as one “sub-table”. This, however, requires updating of section_number and last_section_number every time when the table is sent in different transport stream, the required updating is carried out in a re-multiplexer, whereas the proposed sub-table structure would not require any changes in a sub-table (Sub-T) to be re-transmitted in another transport stream. Instead, the mother table (MT) is introduced, and is the only table to be modified individually for each transport stream. In the section level embodiment, nearly every SI table can be divided into sections. Thus, the for loop data structure establish a section. It can be divided into several sections in such a way that some loops are in one sections and the other in other sections. The sections must be numbered increasingly starting from null and the last_section_number depicts the amount. The re-multiplexer catches the sections and forwards them. However, the sections should be renumbered and the last_section_number must be added to show the total amount.

Particular implementations and embodiments of the invention have been described. It is clear to a person skilled in the art that the invention is not limited to details of the embodiments presented above, but that it can be implemented in other embodiments using equivalent means without deviating from the characteristics of the invention. The scope of the invention is only limited by the attached claims.

1. A method for announcing transport streams that a digital broadcast network is adapted to transmit, the method comprising the steps of:
establishing at least one service information table for enabling a end user terminal to obtain the transport streams,
splitting the at least one service information table into sub-tables, wherein each sub-table identifies a certain transport stream, and
establishing a mother table for maintaining a sub-table of the certain transport stream and sub-tables of adjacent transport streams of the certain transport stream.

2. A method according to claim 1, wherein the sub-table comprises a for loop of the at least one service information table.

3. A method according to claim 2, wherein the for loop comprises a section of the at least one service information table.

4. A method according to claim 2, wherein the for loop comprises a cycle of for loops of the at least one service information table.

5. A method according to claim 2, wherein the for loop comprises a transport stream identifier for uniquely identifying the certain transport stream of the sub-table.

6. A method according to claim 1, wherein at least one headend equipment for a cell of the digital broadcast network performs the step of splitting.

7. A method according to claim 6, wherein an operator runs the at least one headend.

8. A method according to claim 1, wherein at least one the service information table comprises a Bouquet Association Table.

9. A method according to claim 1, further comprising building a local table based on the sub-table of the certain transport stream.

10. A method according to claim 1, wherein the mother table identifies an amount of the sub-tables.

11. A method according to claim 1, wherein the mother table identifies an updating of the sub-table.

12. A method according to claim 1, further comprising the step of updating the adjacent transport streams periodically about the sub-table.

13. A method according to claim 1, further comprising the step of re-transmitting the sub-table to the adjacent transport streams.

14. A method according to claim 13, wherein the step of re-transmitting comprises individual re-transmitting.

15. A method according to claim 13, wherein the step of re-transmitting comprises periodic re-transmitting.

16. A method according to claim 13, wherein the sub-table is adapted to be retransmitted without any further modification of the sub-table.

17. A method according to claim 1, further comprising the step of performing a handover function for the transport streams when a mobile end user terminal is moving from a cell of the certain transport stream to any adjacent transport stream.

18. A method according to claim 1, further comprising the step of performing a roaming function for the transport streams when a mobile end user terminal is moving from a cell of the certain transport stream to any adjacent transport stream.

19. A method according to claim 1, wherein the certain transport stream comprises a local transport stream of a cell of the digital broadcast network.

20. A method according to claim 1, wherein the transport streams comprise MPEG transport streams.

21. A method according to claim 1, wherein the transport stream comprises transmission according to Digital Video Broadcasting.

22. A method according to claim 1, wherein the transport stream comprises a terrestrial digital video broadcasting (DVB-T).

23. A method according to claim 1, wherein the transport stream comprises multicast.

24. A method according to claim 1, wherein the transport stream comprises unicast.

25. A method for obtaining a service within broadcast transport streams, the method comprising:
establishing service information for enabling at least one end user terminal to obtain a sub-table of the service information, wherein the service information is adapted to be split into sub-tables, and based on the sub-table, establishing a local table announcing at least one local transport stream containing the service, wherein the local table is adapted to be delivered to the at least one end user terminal and the local table is adapted to identify the at least one local transport stream for an announcement to adjacent transport streams.

26. A method for advertising a local transport stream which is adapted to be transmitted within a broadcast transmission network, the method comprising the steps of:
establishing service information tables for enabling a end user terminal to obtain transport streams,
splitting a certain service information table into sub-tables, wherein each sub-table identifies coincident local transport stream, and the coincident local transport stream contains identification of adjacent transport streams of the coincident local transport stream, and
distributing the sub-tables to an adjacent service provider of the coincident local transport stream.

27. A method for announcing a service delivered within a transport stream of a cell that a broadcast network is adapted to transmit, the method comprising:
establishing service information for guiding a end user terminal to discover transport streams, and
splitting the service information into sub-tables, wherein each sub-table identifies the transport stream of the cell, and the transport stream of the cell contains identification of transport streams of neighbouring cells of the transport stream.

28. A method for receiving a transport stream that a digital broadcast network is adapted to transmit, the method comprising the steps of:
receiving a broadcast transmission, and
means for discovering a mother table from the broadcast transmission, the mother table announcing a set of sub-tables each sub-table identifying a local transport stream, wherein the transport streams indicated in the mother table comprise adjacent transport streams to each other.

29. A end user terminal for obtaining a transport stream that a digital broadcast network is adapted to transmit, the receiver comprising:
means for receiving a broadcast transmission, and
means for discovering a mother table from the broadcast transmission, the mother table announcing a set of sub-tables each sub-table identifying a local transport stream, wherein the transport streams indicated in the mother table comprise adjacent transport streams to each other.

30. A end user terminal according to claim 29, further comprising means for interaction with a service provider providing the transport stream.

31. A end user terminal according to claim 29, wherein the receiver comprises a wireless receiver for receiving the transport stream.

32. A end user terminal according to claim 29, wherein the end user terminal comprises a broadcast cellular mobile end user terminal.

33. A system for delivering broadcast transport streams delivering services, the system comprising:
headends for splitting a service information table into sub-tables and for establishing a mother table, wherein each sub-table identifies a transport stream of a coincident headend, and wherein the mother table identifies the transport stream of the coincident headend and transport streams of adjacent headends to the coincident headend, and
at least one end user terminal for obtaining the broadcast transport streams.

34. A system according to claim 33, wherein the broadcast transport streams comprises transmission according to Digital Video Broadcasting (DVB).

35. A system according to claim 33, wherein the broadcast transport streams comprises a terrestrial digital video broadcasting (DVB-T).

36. A system according to claim 33, wherein the broadcast transport stream comprises multicast.

37. A system according to claim 33, wherein the broadcast transport stream comprises unicast.

38. A system according to claim 33, wherein the at least one end user terminal comprises a wireless broadcast receiver.

39. A system according to claim 33, wherein the headends comprise cells of a cellular broadcast network and the at least one end user terminal comprise a mobile cellular digital broadcast end user terminal.

40. A transmitter for delivering broadcast transport streams delivering services, the transmitter comprising:
means for establishing at least one service information table for enabling a end user terminal to obtain the transport streams,
means for splitting the at least one service information table into sub-tables and for establishing a mother table, wherein each sub-table identifies a transport stream of a coincident headend, and wherein the mother table identifies the transport stream of the coincident headend and transport streams of adjacent headends to the coincident headend.

41. A computer program product comprising a program of instructions executable by a computing system for processing an announcement of transport streams that a digital broadcast network is adapted to transmit, the computer program product comprising:
computer program code for causing the system to establish at least one service information table for enabling a end user terminal to obtain the transport streams,
computer program code for causing the system to split the at least one service information table into sub-tables, wherein each sub-table identifies a certain transport stream, and
computer program code for causing the system to establish a mother table for maintaining a sub-table of the certain transport stream and sub-tables of adjacent transport streams of the certain transport stream.
